(19) United States
(12) Patent Application Publication
(10) Pub. No.: US 2012/0045685 A1
(43) Pub. Date: Feb. 23, 2012

(54) ELECTRIC STORAGE DEVICE

(75) Inventors: Daisuke Seki, Sendai-shi (JP); Yukinori Hato, Sendai-shi (JP); Masako Ooya, Sendai-shi (JP); Katsuhiro Yoshida, Sendai-shi (JP); Risa Miyagawa, Sendai-shi (JP); Kouji Maeda, Sendai-shi (JP)

(73) Assignee: NEC Tokin Corporation, Sendai-shi, Miyagi (JP)

(21) Appl. No.: 13/266,964

(22) PCT Filed: Apr. 5, 2011
(86) PCT No.: PCT/JP2011/002024

§ 371 Date: Oct. 28, 2011

(30) Foreign Application Priority Data
Apr. 6, 2010 (JP) 2010-087434

(51) Int. Cl. H01M 4/13; H01G 4/30; H01M 4/139; H01G 9/058; H01M 10/04

(52) U.S. Cl. 429/153; 29/25.03; 29/623.1; 361/301.4

(57) ABSTRACT

To provide an electric storage device whose negative electrode can be doped with lithium ions in a short time and whose resistance can be lowered. An electric storage device including a unit that is obtained by alternately stacking a positive-electrode sheet 9 and a negative-electrode sheet 10 with a separator 3 interposed therebetween, the positive electrode sheet 9 including a positive-electrode active material layer 1 and a positive-electrode charge collector 4, and the negative electrode sheet 10 including a negative-electrode active material layer 2 and a negative-electrode charge collector 5, in which a foil, an etching foil, or a porous lath foil is used as the positive-electrode charge collector 4 and the negative-electrode charge collector 5, a cut is made in a coating area of the positive-electrode active material layer 1 and the negative-electrode active material layer 2, and a lithium supply source is disposed so as to be opposed to the negative electrode sheet 10 of the unit.

### TECHNICAL FIELD

The present invention relates to an electric storage device that is a hybrid capacitor or a secondary battery.

### BACKGROUND ART

In consideration for the oil reserve problem and for the ecology such as the global warming, electric storage devices have been studied as an energy source for driving a motor used in electric vehicles and the like or as the key device of energy regenerative systems. Further, the applications to various new purposes such as applications to uninterrupted power supply systems, wind power generators, and solar power generators have been also studied. Accordingly, electric storage devices have been highly expected to be the next-generation devices.

In recent years, it has been desired to further increase the energy density of electric storage devices and to decrease their resistance in the applications to energy resources and energy regeneration systems.

In general, electric double-layer capacitors are categorized into an aqueous electrolytic solution type and a non-aqueous electrolytic solution type according to their used electrolytic solution. The withstand voltage of a single aqueous electrolytic solution type electric double-layer capacitor is about 1.2 V and the withstand voltage of the non-aqueous electrolytic solution type is about 2.7 V. To increase the energy capacity that can accumulated in an electric double-layer capacitor, it is important to raise this withstand voltage. However, it is very difficult because of its structure.

Meanwhile, a lithium-ion secondary battery is composed of a positive electrode mainly composed of a transition metal oxide containing lithium, and a negative electrode mainly composed of a carbon material that can absorb and detach lithium ions, and an organic electrolytic solution containing a lithium salt. When a lithium-ion secondary battery is charged, lithium ions are detached from the positive electrode and absorbed into the carbon material of the negative electrode. On the other hand, when the lithium-ion secondary battery is discharged, lithium ions are detached from the negative electrode and absorbed into the metal oxide of the positive electrode. Compared to the electric double-layer capacitor, the lithium-ion secondary battery has a higher voltage and a larger capacity. However, the lithium-ion secondary battery suffers from a problem that the internal resistance is higher and the resistance cannot be easily lowered. Nevertheless, if this problem can be solved, the lithium-ion secondary battery is considered to be a promising electric storage device.

A lithium ion capacitor uses an activated carbon for the positive electrode and uses a carbon material capable of absorbing and detaching lithium ions for the negative electrode. Since absorption/detachment reactions of lithium ions occur at the negative electrode at the time of charging/discharging, the potential difference between both electrodes that is actually generated inside the capacitor shifts in a lower-value range, which is closer to the case where a lithium metal is used for the negative electrode. Therefore, it is possible to increase the withstand voltage in comparison to conventional electric double-layer capacitors using an activated carbon for the positive and negative electrodes, and thereby to increase the energy amount that can be accumulated in the capacitor (energy increase) in comparison to the electric double-layer capacitors. In addition, the lithium ion capacitor has a low resistance. Accordingly, the lithium ion capacitor is a promising device that can solve the above-mentioned problems.

To lower the resistance of the lithium-ion secondary battery and the lithium ion capacitor, it is necessary to use a technique to implant (dope) lithium into the negative electrode. As a method for reducing the doping time and thereby shortening the manufacturing period, the following methods have been proposed.

Patent literature 1 discloses an organic electrolytic battery in which: each of the positive-electrode charge collector and the negative-electrode charge collector has pores piercing between the front and rear surfaces; the negative-electrode active material can reversibly support lithium; lithium originated from the negative electrode is moved and supported between the front and rear surfaces of the electrode by electrochemical contact with lithium that is disposed so as to be opposed to the negative electrode or the positive electrode; and the opposed area of that lithium is equal to or less than 40% of the negative electrode area.

Patent literature 2 discloses an organic electrolytic battery in which: each of the positive-electrode charge collector and the negative-electrode charge collector has pores piercing between the front and rear surfaces and its porosity is not less than 1% and not greater than 30%; the negative-electrode active material can reversibly support lithium; and lithium that is disposed so as to be opposed to the positive electrode or the negative electrode is brought into electrochemical contact with the negative electrode, thereby causing all or part of lithium originated from the negative electrode to be directly supported by negative electrodes adjacent to that lithium and to be supported by other negative electrodes by causing the lithium to permeate through at least one positive electrode layer.

### CITATION LIST

### Patent Literature

Patent literature 1: Japanese Patent No. 3485935
Patent literature 2: Japanese Patent No. 4126157

### SUMMARY OF INVENTION

### Technical Problem

However, even when charge collectors with through-pores are used, it is still desired to make further improvement so that lithium ions are uniformly doped into the negative electrode in a short time.

Note that, by using a foil for the charge collector, it is possible to solve problems that are inherent in the charge collector with through-pores, such as higher cost and lower productively. However, the problem that negative electrode cannot be uniformly doped with lithium ions in a short time is still unsolved.

That is, a technical problem of the present invention is to provide an electric storage device whose negative electrode can be doped with lithium ions in a short time and whose resistance can be lowered.

### Solution to Problem

An electric storage device according to the present invention is an electric storage device including a unit that is obtained by alternately stacking a positive-electrode sheet and a negative-electrode sheet with a separator interposed therebetween, the positive electrode sheet including a positive-electrode active material layer and a positive-electrode charge collector, and the negative electrode sheet including a negative-electrode active material layer and a negative-electrode charge collector, in which a foil, an etching foil, or a porous lath foil is used as the positive-electrode charge collector and the negative-electrode charge collector, a cut is made in a coating area of the positive-electrode active material layer and the negative-electrode active material layer, and a lithium supply source is disposed so as to be opposed to the negative electrode sheet of the unit.

Further, in the electric storage device according to the present invention, each of the positive-electrode active material layer and the negative-electrode active material layer has a quadrangular shape, and in each of the positive-electrode sheet and the negative-electrode sheet, a ratio of a sum of a length of the cut to a sum of lengths of four sides of the positive-electrode active material layer and the negative-electrode active material layer is not less than 10% and not greater than 100,000%.

Further, in the electric storage device according to the present invention, a number of the cut in the coating area of each of the positive-electrode active material layer and the negative-electrode active material layer is not less than 2 and not greater than 4,000.

Further, in the electric storage device according to the present invention, an interval between the cuts is not smaller than 0.1 mm and not greater than 10 cm.

Further, in the electric storage device according to the present invention, an end of the cut does not reach a side of the positive-electrode sheet or the negative-electrode sheet.

Further, in the electric storage device according to the present invention, a plurality of units each of which is obtained by stacking the positive-electrode sheet, the negative-electrode sheet, and the separator are connected to one lithium supply source.

Further, in the electric storage device according to the present invention, the electric storage device is a hybrid capacitor or a lithium-ion secondary battery.

### Advantageous Effects of Invention

According to the present invention, it is possible to provide an electric storage device whose negative electrode can be doped with lithium ions in a short time and whose resistance can be lowered.

### BRIEF DESCRIPTION OF DRAWINGS

FIG. 1 is a cross-section showing a first overall structure of an electric storage device according to the present invention;

FIG. 2A shows a first example of an electric storage device according to the present invention, and is a top view of a negative electrode sheet;

FIG. 2B shows a first example of an electric storage device according to the present invention, and is a top view of a positive electrode sheet;

FIG. 3A shows a second example of an electric storage device according to the present invention, and is a top view of a negative electrode sheet;

FIG. 3B shows a second example of an electric storage device according to the present invention, and is a top view of a positive electrode sheet;

FIG. 4A shows a third example of an electric storage device according to the present invention, and is a top view of a negative electrode sheet;

FIG. 4B shows a third example of an electric storage device according to the present invention, and is a top view of a positive electrode sheet;

FIG. 5A shows a fourth example of an electric storage device according to the present invention, and is a top view of a negative electrode sheet;

FIG. 5B shows a fourth example of an electric storage device according to the present invention, and is a top view of a positive electrode sheet;

FIG. 6A shows a fifth example of an electric storage device according to the present invention, and is a top view of a negative electrode sheet;

FIG. 6B shows a fifth example of an electric storage device according to the present invention, and is a top view of a positive electrode sheet;

FIG. 7A shows a sixth example of an electric storage device according to the present invention, and is a top view of a negative electrode sheet;

FIG. 7B shows a sixth example of an electric storage device according to the present invention, and is a top view of a positive electrode sheet;

FIG. 8A shows a seventh example of an electric storage device according to the present invention, and is a top view of a negative electrode sheet;

FIG. 8B shows a seventh example of an electric storage device according to the present invention, and is a top view of a positive electrode sheet;

FIG. 9A shows a supplementary example of an electric storage device according to the present invention, and is a top view of a negative electrode sheet;

FIG. 9B shows a supplementary example of an electric storage device according to the present invention, and is a top view of a positive electrode sheet;

FIG. 10A shows an eighth example of an electric storage device according to the present invention, and is a top view of a negative electrode sheet;

FIG. 10B shows an eighth example of an electric storage device according to the present invention, and is a top view of a positive electrode sheet;

FIG. 11A shows a supplementary example of an electric storage device according to the present invention, and is a top view of a negative electrode sheet;

FIG. 11B shows a supplementary example of an electric storage device according to the present invention, and is a top view of a positive electrode sheet;

FIG. 12A shows a supplementary example of an electric storage device according to the present invention, and is a top view of a negative electrode sheet;

FIG. 12B shows a supplementary example of an electric storage device according to the present invention, and is a top view of a positive electrode sheet;

FIG. 13A shows a first comparative example of an electric storage device, and is a top view of a negative electrode sheet;

FIG. 13B shows a first comparative example of an electric storage device, and is a top view of a positive electrode sheet;

FIG. 14A shows a second comparative example of an electric storage device, and is a top view of a negative electrode sheet;

FIG. 14B shows a second comparative example of an electric storage device, and is a top view of a positive electrode sheet; and

FIG. 15 is a cross-section showing a second overall structure of an electric storage device according to the present invention.

### DESCRIPTION OF EMBODIMENTS

Exemplary embodiments according to the present invention are explained hereinafter.

An electric storage device according to the present invention is an electric storage device including a unit that is obtained by alternately stacking a positive-electrode sheet and a negative-electrode sheet with a separator interposed therebetween, in which: the positive electrode sheet includes a positive-electrode active material layer capable of reversibly supporting an anion or a cation and capable of reversibly absorbing/detaching lithium, and a positive-electrode charge collector; and the negative electrode sheet includes a negative-electrode active material layer capable of reversibly supporting an anion or a cation and capable of reversibly absorbing/detaching lithium, and a negative-electrode charge collector. It has been found out that, in the electric storage device, it is possible to uniformly dope lithium ions into the negative electrode in a short time and to lower the resistance by using a foil, a foil with pores piercing between the front and rear surfaces, or an etching foil for the positive-electrode charge collector and the negative-electrode charge collector, using a non-aqueous solution containing lithium ions for the electrolytic solution, forming a cut(s) in the coating area of the positive-electrode active material layer and the negative-electrode active material layer, and disposing a lithium supply source in the unit in such a manner that the lithium supply source is in parallel with and opposed to the electrode sheet.

According to the present invention, since the cut(s) is formed in the foil, the diffusion distance of lithium ions, which diffuse through the electrolytic solution, becomes shorter, and thereby reducing the time necessary to carry out the doping to a predetermined quantity. Further, the lithium ions are uniformly doped into the negative electrode through the cut(s), thus reducing the resistance against the charge transfer in the negative electrode sheet and thereby lowering the resistance.

Further, even when a charge collector with through-pores is used, the uniform doping into the negative-electrode active material layer can be completed in a short time because the lithium ions diffuse through the electrolytic solution. By making the cut(s) in the charge collector having no through-pores, it is possible to use an inexpensive foil, and thereby reducing the material cost. In addition, by using a charge collector having no pores, the adhesion to the active material layer is improved, and thereby lowering the resistance. Therefore, according to the present invention, it is possible to provide an electric storage device having a large capacity, a low resistance, a low cost, and improved productivity.

An electric storage device according to the present invention, which is a hybrid capacitor or a secondary batter, is well suited for the doping of lithium ions into the negative electrode.

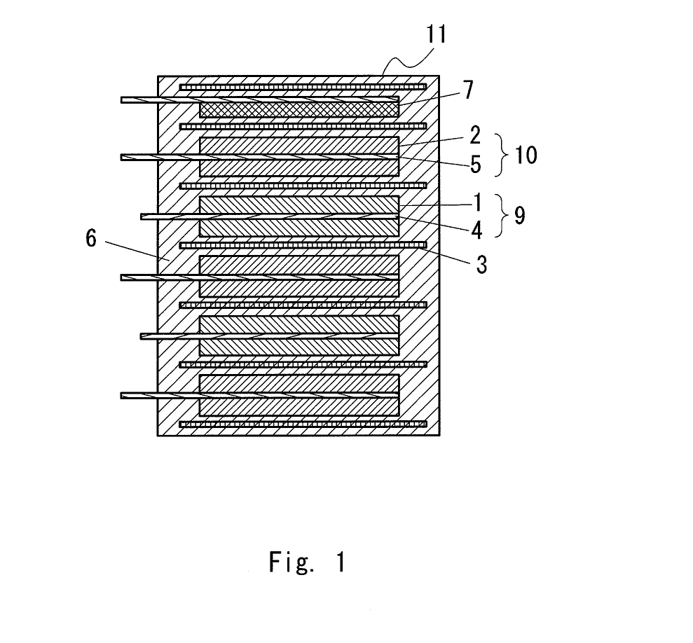

FIG. 1 is a cross-section showing a structure of an electric storage device. As shown in FIG. 1, a positive-electrode sheet 9 includes a positive-electrode charge collector 4, and a positive-electrode active material layer 1 including an active material capable of reversibly supporting an anion or a cation and capable of reversibly absorbing/detaching lithium. A negative-electrode sheet 10 includes a negative-electrode charge collector 5, and a negative-electrode active material layer 2 including an active material capable of reversibly supporting an anion or a cation and capable of reversibly absorbing/detaching lithium. A separator 3 is interposed between the positive-electrode sheet 9 and the negative-electrode sheet 10.

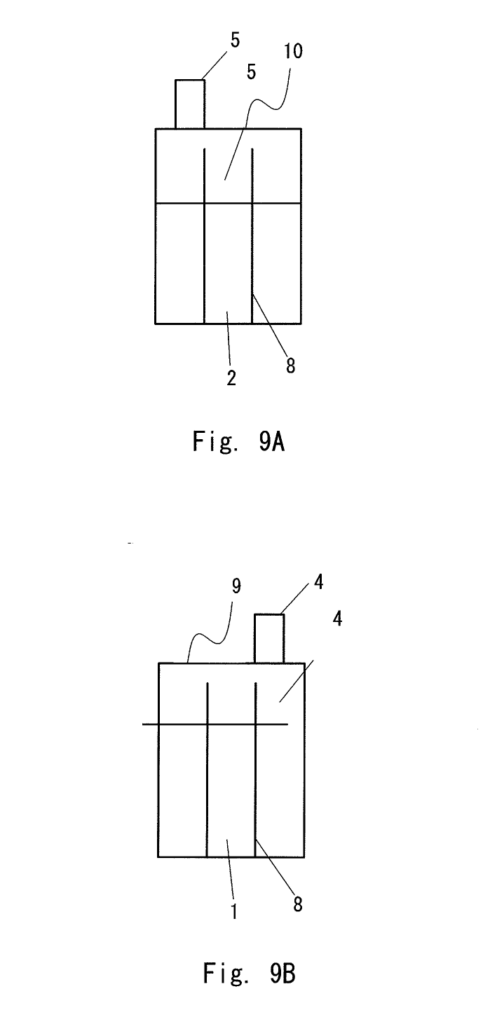

Further, after the positive-electrode sheet 9 and the negative-electrode sheet 10 are placed on the positive-electrode charge collector 4 and the negative-electrode charge collector 5 respectively, a cut(s) is made in the positive-electrode charge collector 4 and the negative-electrode charge collector 5. The cut 8 is generally formed in areas of the positive-electrode charge collector 4 and negative-electrode charge collector 5 that are coated with the positive-electrode active material layer 1 and the negative-electrode active material layer 2 respectively. However, as shown in FIGS. 9A and 9B, the cut may be formed in areas that are not coated with the positive-electrode active material layer 1 and the negative-electrode active material layer 2. The active material layer that is applied on the charge collector should have a quadrangular shape.

In the positive-electrode active material layer and the negative-electrode active material layer, the ratio of the sum of lengths of the cuts to the sum of lengths of the four sides is preferably not less than 10% and not greater than 100,000%. More preferably, the ratio is not less than 10% and not greater than 350%. When the ratio is less than 10%, the effect of reducing the diffusion distance of lithium ions could become smaller, whereas when the ratio is greater than 100,000%, the manufacturing process could become complicated. Similarly, the interval between the cuts is preferably not smaller than 0.1 mm and not greater than 10 cm. More preferably, the interval is not smaller than 2 mm and not greater than 10 cm. When the interval is smaller than 0.1 mm, the manufacturing process could become complicated, whereas when the interval is greater than 10 cm, the effect of reducing the diffusion distance of lithium ions could become smaller.

Further, the number of the cuts in each of the positive-electrode active material layer and the negative-electrode active material layer is not less than 1 and not greater than 4,000. More preferably, the number of cuts is not less than 2 and not greater than 14. When there is no cut (zero), the effect of reducing the diffusion distance of lithium ions could not be achieved, whereas when the number of cuts is greater than 4,000, the manufacturing process could become complicated.

The positive-electrode sheet 9 and the negative-electrode sheet 10 are alternately stacked on top of one another with the separator 3 interposed therebetween, and thereby forming a unit. Further, the formed unit is impregnated with an electrolytic solution 6, which is a non-aqueous solution containing lithium ions. A lithium metal 7, which serves as a lithium supply source, is disposed on the outermost part of the unit, and is disposed so as to be opposed to the surface of the positive-electrode active material layer 1 and the negative-electrode active material layer 2.

The term “unit” in this specification means a stacked body that is obtained by alternately stacking the positive-electrode sheet 9 and the negative-electrode sheet 10 with the separator 3 interposed therebetween in such a manner that the negative-electrode sheet 10 or the positive-electrode sheet 9 is disposed in the outermost part, and includes at least one negative-electrode sheet 10 and at least one positive-electrode sheet 9. The number of the positive-electrode sheets 9 and the number of the negative-electrode sheets 10 included in the unit are determined as appropriate according to the defined capacity. However, to prevent the deterioration of the mobility of lithium ions (doping advancing speed) due to the increase of the density of the positive-electrode sheets 9 and the negative-electrode sheets 10, the number of the positive-electrode sheets 9 and the number of the negative-electrode sheets 10 are both preferably less than or equal to 20.

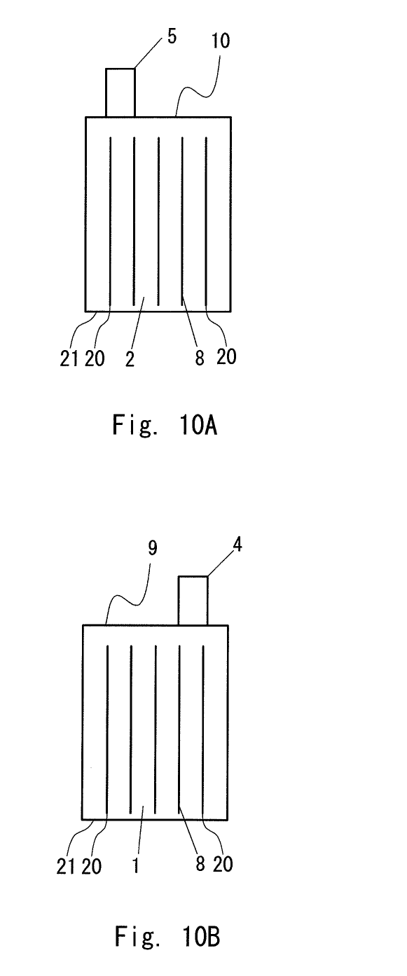

Further, as shown in FIGS. 10A and 10B, the end 20 of the cut 8 does not necessarily have to reach the side 21 that is opposite to the side from which the charge collectors 4 and 5 of both sheets 9 and 10 are exposed. In this way, since both sheets 9 and 10 are not torn apart at the side 21, the workability can be significantly improved in the assembling process and the like of both sheets 9 and 10. The gap between the end 20 of the cut 8 and the side 21 is preferably not less than 0.3 mm and not greater than 50 mm. When the gap is less than 0.3 mm, a crack is likely to occur at the side 21 during the manufacturing process. When the gap is greater than 50 mm, the possibility of insufficient lithium-ion doping at or near the side 21 becomes higher.

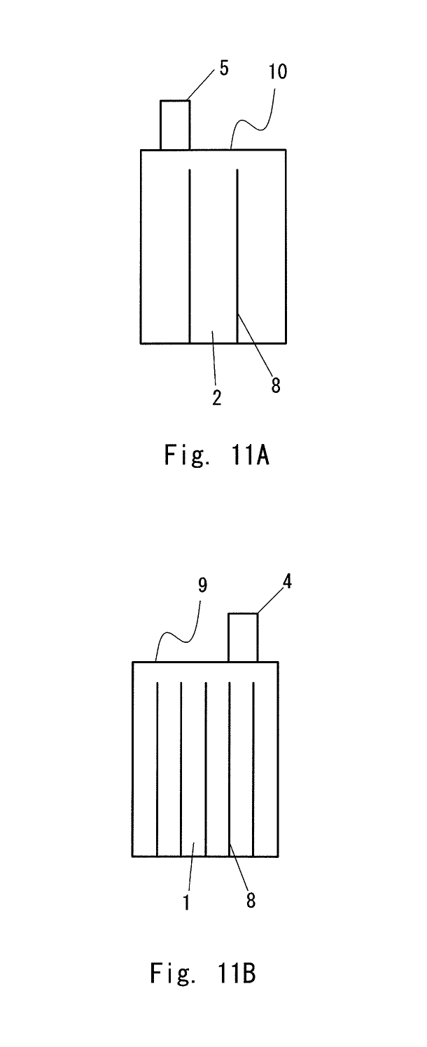

Further, as shown in FIGS. 11A and 11B, the number of the cuts 8 and the interval between the cuts 8 do not necessarily have to be the same between both sheets 9 and 10.

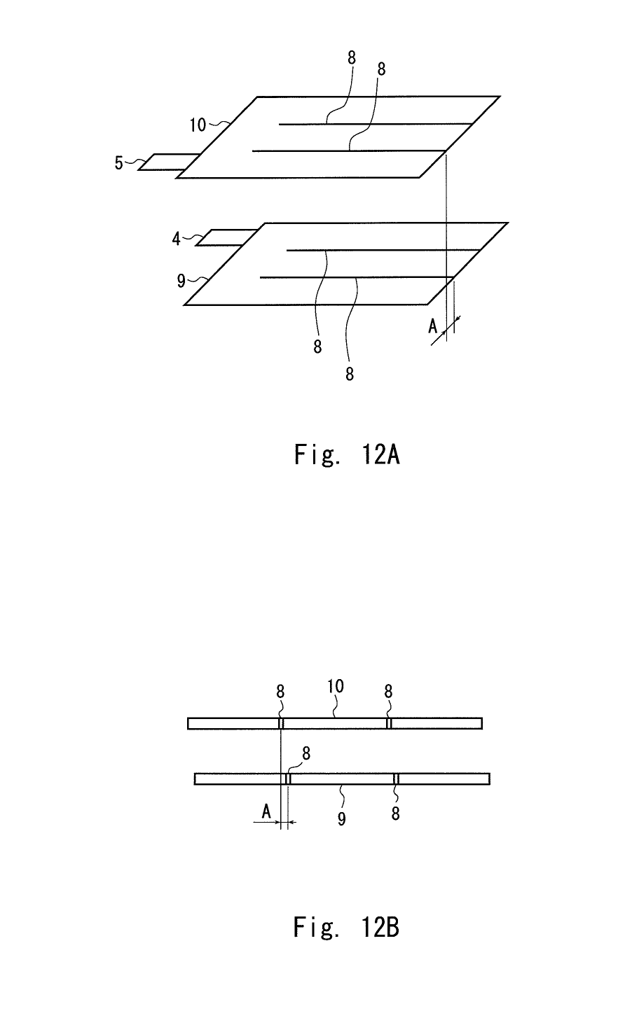

Further, as shown in FIGS. 12A and 12B, even when the interval between the cuts 8 are the same between both sheets 9 and 10, the positions of the cuts 8 when the sheets 8 and 9 are stacked can be somewhat misaligned from each other by a gap A. However, if this gap is too large, the electrode sheets 9 and 10 could protrude from the separator 3 when they are stacked, and thus raising the possibility of failures such as a short circuit. Therefore, the gap A is preferably restricted within a range of 5 mm, and more preferably within a range of 2 mm.

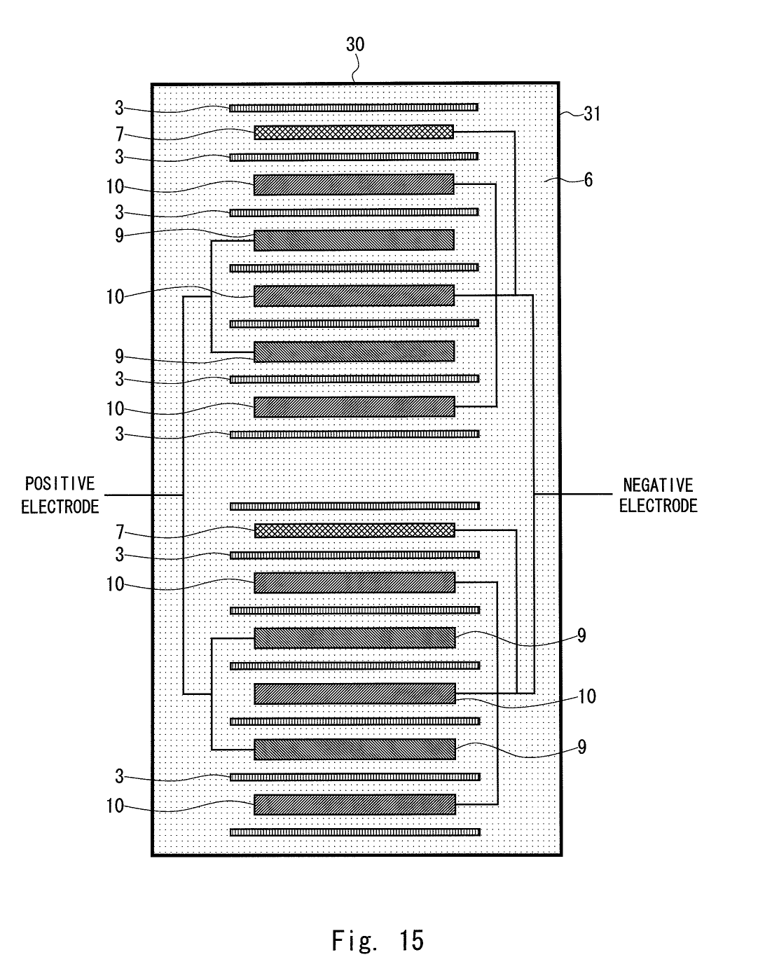

Further, to increase the number of lithium supply sources, it is also conceivable to increase the number of units while reducing the number of the positive-electrode sheet 9 and the negative-electrode sheet 10 included in each unit. FIG. 15 shows an example of an electric storage device 30 in which two units are contained in one cell 31. Two lithium metals 7 are contained in the electric storage device 30, and for each of the lithium metals 7, two positive-electrode sheets 9, three negative-electrode sheets 10, and seven separators 3 are stacked. Each of the lithium metals 7, the positive-electrode sheets 9, the negative-electrode sheets 10, and the separators 3 is impregnated with an electrolytic solution 6.

Further, when the unit is impregnated with the electrolytic solution, which is a non-aqueous solution containing lithium ions, lithium ions are doped into the negative-electrode active material layer from the lithium ion supply source. Note that in the present invention, the method for doping the negative-electrode active material layer with lithium ions in advance is not limited any particular methods. Examples of the doping method include a method for electrochemically doping a negative-electrode active material layer with lithium ions, and a method in which a negative-electrode active material layer is physically short-circuited with a lithium metal.

As for the lithium ion supply source, any substance capable of supplying lithium ions such as a lithium metal and a lithium-aluminum alloy can be used. The lithium ion supply source preferably has the same size as the negative-electrode active material layer or is smaller than the negative-electrode active material layer by 1 to 2 mm in order to dope the negative-electrode active material layer with lithium ions. Its thickness can be changed according to the doping amount, and the thickness is preferably not less than 5 μm and not greater than 400 μm. When the thickness is greater than 400 μm, there is a possibility that the lithium ion supply source remains. When the thickness is less than 5 μm, it could be too thin, making the handling difficult.

As for the material for the negative-electrode charge collector, various materials that are usually used in lithium ion secondary batteries and the likes can be used. Examples of the material for the negative-electrode charge collector and for charge collector for supplying a lithium metal include stainless steel, copper, and nickel. Further, as for the charge collector, a rolled foil, an electrolytic foil, a pierced foil with pores piercing between the front and rear surfaces, and a net-like foil (hereinafter called “porous lath foil”) such as an expand metal can be used.

The negative-electrode active material, which is the principal ingredient of the negative-electrode active material layer, is formed from a substance capable of reversibly doing lithium ions. Examples of the negative-electrode active material include a graphite material used for the negative electrode of a lithium-ion secondary battery, a graphitization-resistant carbon material, a carbon material such as coke, and a polyacene-based material. To achieve a lower resistance and a lower cost, a preferable material is a graphite material or a graphitization-resistant carbon material.

As for the positive-electrode charge collector, aluminum, stainless steel, and the like can be used. To achieve a lower resistance and a lower cost of the positive-electrode active material layer, it is preferable to use an aluminum etching foil that is commonly used in aluminum electrolytic capacitors and double-layer capacitors. An aluminum etching foil has an increased specific surface by carrying out an etching process. Therefore, the area in which the aluminum etching foil is in contact with the positive-electrode active material layer is increased and the resistance is thereby lowered, thus improving the output characteristic. Further, since the aluminum etching foil is a widely-used material, the cost is expected to be reduced. Either the etching process for a rolled foil or that for an electrolytic foil can be used as the etching process for the aluminum etching foil. Further, various rolled foils, electrolytic foils, and porous lath foils that are used for lithium-ion secondary batteries can be also used.

The positive-electrode active material, which is the principal ingredient of the positive-electrode active material layer, is formed from a substance capable of reversibly supporting an anion or a cation. Examples of the positive-electrode active material include a phenolic-resin-based activated carbon having a polarization property, a coconut-husk-based activated carbon, a petroleum-coke-based activated carbon, and a carbon material such as a polyacene. Further, materials for the positive electrode of a lithium ion secondary battery can be also used.

If necessary, a conductivity-improving agent and/or a binder may be added in the positive-electrode active material layer and/or the negative-electrode active material layer. Examples of the conductivity-improving agent include graphite, carbon black, ketjen black, a vapor-deposited carbon, a carbon nanotube. In particular, carbon black and graphite are preferable. Examples of the binder include a rubber-based binder such as a styrene butadiene rubber (SBR), a fluorine-containing resin such as poly tetra-fluoro ethylene and polyvinylidene fluoride, and a thermoplastic resin such as polypropylene, polyethylene, and the like.

As for the electrolytic solution, a non-aqueous solution containing lithium ions is used. Examples of the solvent of the electrolytic solution composed of a non-aqueous solution containing lithium ions include ethylene carbonate, propylene carbonate, dimethyl carbonate, diethyl carbonate, methyl ethyl carbonate, y-butyl lactone, acetinitrile, dimethoxy ethane, tetrahydrofuran, dioxolane, methylene chloride, and sulfolane. Further, a mixed solvent of two or more of these solvents can be also used. Among them, a solvent containing at least either propylene carbonate or ethylene carbonate is preferable in terms of the characteristic.

Further, any substance that generates lithium ions by ionization can be used as the electrolyte that is dissolved into the above-described solvent. Examples of the electrolyte include LiI, LiClO₄, LiAsF₆, LiBF₄, and LiPF₆. These solutes are preferably dissolved into the above-described solvent in an amount equal to or greater than 0.5 mol/L. In particular, the solute is preferably dissolved in an amount of no less than 0.5 mol/L and no greater than 2.0 mol/L.

Examples of the present invention are described hereinafter in detail.

In particular, Examples 1 to 7 and Comparative examples 1 and 2 are explained hereinafter. Note that 20 lithium ion capacitors using a foil for the charge collector were manufactured in each of Examples 1, 2, 3, 5, 6 and 7 and Comparative example 1. Further, twenty lithium ion capacitors using a porous lath foil were manufactured in each of Example 4 and Comparative example 2.

### Example 1

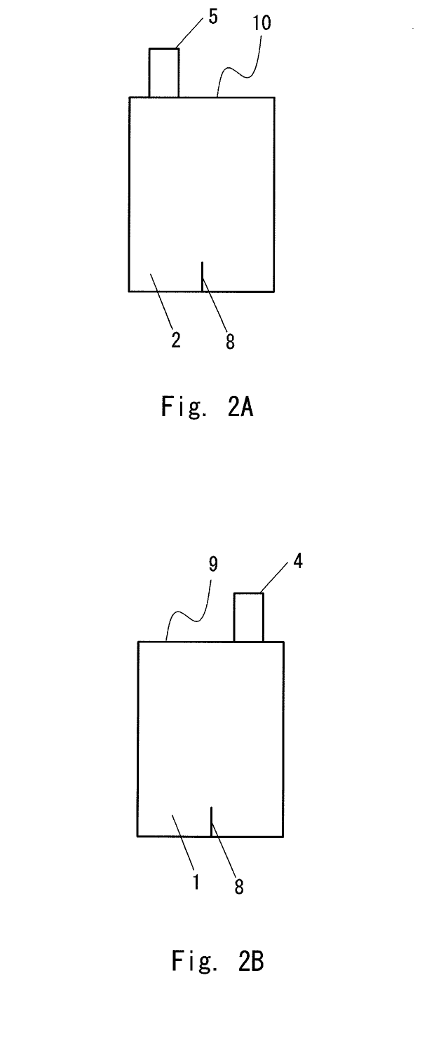

FIGS. 2A and 2B slow a first configuration example of an electric storage device according to the present invention. In particular, FIG. 2A is a top view of a negative-electrode sheet and FIG. 2B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. A single cut 8 having a length of 14 mm was formed, in each sheet, on the side opposite to the side from which the negative-electrode charge collector 5 or the positive-electrode charge collector 4 protruded and was exposed.

Mixed powder comprising 92 wt.pts. of powder of a phenol-based activated carbon having a specific surface of 1500 m²/g, which was a positive-electrode active material, and 8 wt.pts. of graphite, which was a conductive agent, was prepared. In the mixed powder, 3 wt.pts. of a styrene butadiene rubber and 3 wt.pts. of carboxyl methyl cellulose were added as binders, and water was added in an amount of 200 wt.pts. as a solvent. Then, they were mixed and kneaded into slurry. Next, an aluminum foil having a thickness of 20 μm whose both surfaces were roughened by an etching process was used as a positive-electrode charge collector, and a coating of the above-described slurry was uniformly applied to its both surfaces. After that, it was dried and rolling-pressed. As a result, a positive-electrode sheet in which a positive-electrode active material layer including polarized electrode layers having a thickness of 30 μm on both sides was formed was obtained. The thickness of this positive-electrode sheet was 80 μm. Further, the charge collector protrudes in a tab shape from part of the end face of the positive-electrode sheet to form an electrode plate so that the positive-electrode sheet can be taken out. No positive-electrode active material layer was formed and the aluminum foil was thereby exposed on both surfaces in that part of the charge collector.

Mixed powder comprising 88 wt.pts. of graphitization-resistant material powder, which was a negative-electrode active material, and 6 wt.pts. of acetylene black, which was a conductive agent, was prepared. In the mixed powder, 5 wt.pts. of a styrene butadiene rubber and 4 wt.pts. of carboxyl methyl cellulose were added as binders, and water was added in an amount of 200 wt.pts. as a solvent. Then, they were mixed and kneaded into slurry. Next, a copper foil having a thickness of 10 μm was used as a negative-electrode charge collector, and a coating of the above-described slurry was uniformly applied to its both surfaces. After that, it was dried and rolling-pressed. As a result, a negative-electrode sheet in which a negative-electrode active material layer including polarized electrode layers having a thickness of 20 μm on both sides was formed was obtained. The thickness of this negative-electrode sheet was 50 μm. Further, the charge collector protrudes in a tab shape from part of the end face of the negative-electrode sheet to form an electrode plate so that the negative-electrode sheet can be taken out. No negative-electrode active material layer was formed and the copper foil was thereby exposed on both surfaces in that part of the charge collector.

A thin plate made of natural cellulose material having a thickness of 30 μm was used as a separator. The separator had such a size and a shape that the separator was slightly larger than the shape of the electrode sheet excluding the electrode plate portion.

The number of positive-electrode sheets stacked in each unit was four. Further, the number of the negative-electrode sheets was five and the number of separators was ten. The size of the positive-electrode sheet excluding the foil-exposed portion was 40 mm×30 mm. Further, the size of the negative-electrode sheet was 40 mm×30 mm and the size of the separator was 41 mm×31 mm. As shown in FIGS. 2A and 2B, a single cut having a length of 14 mm was made, in each of the electrodes sheets, from the side opposite to the side from which the foil was exposed. The separators, the negative-electrode sheets, and the positive-electrode sheets were successively stacked on top of one another in the order of a separator, a negative-electrode sheet, a separator, a positive-electrode sheet, and a separator. The unit was formed in such a manner that one separator was always disposed in each of the uppermost part and the lowermost part of the unit.

The manufactured unit was subjected to a decompression process for six hours at 130° C. by using a vacuum desiccator, and then put into a vessel made of an aluminum laminated film. Further, a lithium metal was disposed in each of the outermost sides of the unit in such a manner that the lithium metal was opposed to the negative-electrode active material layer.

A non-aqueous electrolytic solution obtained by dissolving 1 mol/L of LiPF₆ into a mixed solvent obtained by mixing ethylene carbonate and diethyl carbonate at a one-to-one ratio was poured into the vessel and the vessel was hermetically sealed, completing the manufacturing process of a lithium ion capacitor.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR (Equivalent Series Resistance) of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC (Direct-Current) resistance was calculated based on the voltage drop during the discharging process.

### Example 2

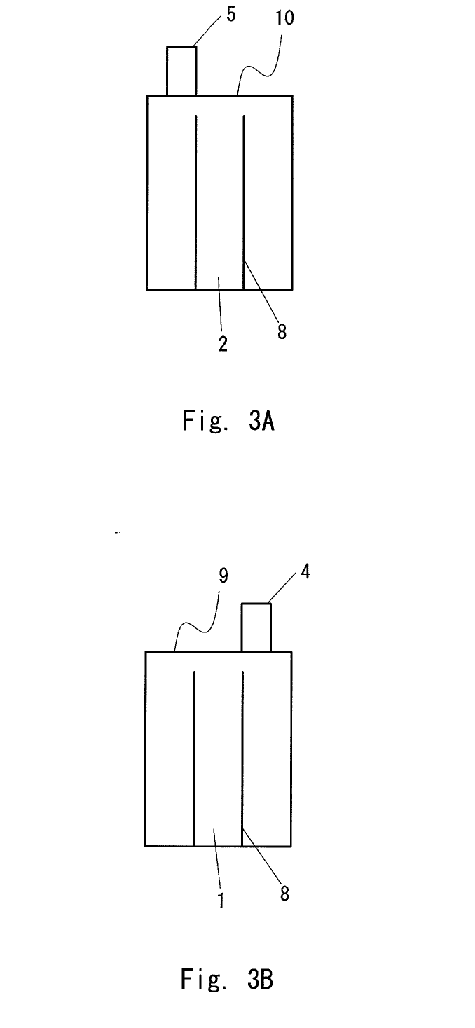

FIGS. 3A and 3B show a second configuration example of an electric storage device according to the present invention. In particular, FIG. 3A is a top view of a negative-electrode sheet and FIG. 3B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. Two cuts 8 having a length of 35 mm were formed with an interval of 10 mm, in each sheet, on the side opposite to the side from which the negative-electrode charge collector 5 or the positive-electrode charge collector 4 protruded and was exposed.

Lithium ion capacitors were manufactured in a similar manner to that of Example 1 except that the two cuts having a length of 35 mm were formed with an interval of 10 mm on the side opposite to the side from which the negative-electrode charge collector or the positive-electrode charge collector protruded and was exposed.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 3

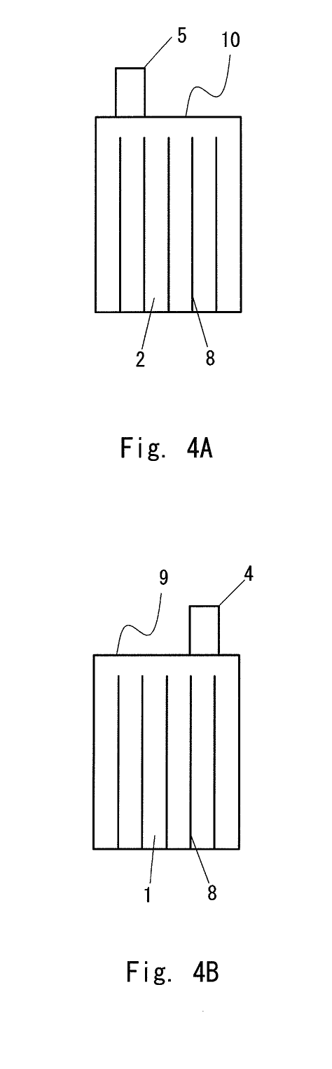

FIGS. 4A and 4B show a third configuration example of an electric storage device according to the present invention. In particular, FIG. 4A is a top view of a negative-electrode sheet and FIG. 4B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. Five cuts 8 having a length of 35 mm were formed with intervals of 5 mm, in each sheet, on the side opposite to the side from which the negative-electrode charge collector or the positive-electrode charge collector 4 protruded and was exposed.

Lithium ion capacitors were manufactured in a similar manner to that of Example 1 except that the five cuts having a length of 35 mm were formed with intervals of 5 mm on the side opposite to the side from which the negative-electrode charge collector or the positive-electrode charge collector protruded and was exposed.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 4

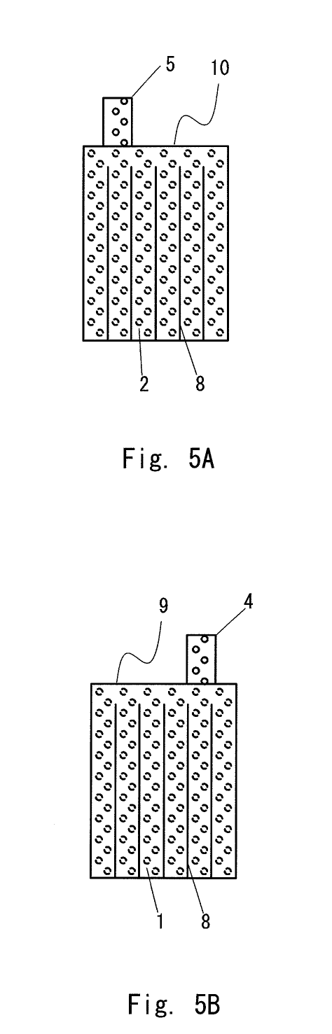

FIGS. 5A and 5B show a fourth configuration example of an electric storage device according to the present invention. In particular, FIG. 5A is a top view of a negative-electrode sheet and FIG. 5B is a top view of a positive-electrode sheet. In the negative-electrode sheet 10, a coating of a negative-electrode active material layer 2 was applied in a rectangular shape to the negative-electrode charge collector 5 formed from a porous lath foil. Further, in the positive-electrode sheet 9, a coating of a positive-electrode active material layer 1 was applied in a rectangular shape to the positive-electrode charge collector 4 formed from a porous lath foil. Five cuts 8 having a length of 35 mm were formed with intervals of 5 mm, in each sheet, on the side opposite to the side from which the negative-electrode charge collector 5 or the positive-electrode charge collector 4 protruded and was exposed.

The positive-electrode charge collector was an aluminum porous lath foil having a thickness of 30 μm, and the negative-electrode charge collector was a copper porous lath foil having a thickness of 25 μm. Lithium ion capacitors were manufactured in a similar manner to that of Example 1 except that the five cuts having a length of 35 mm were formed with intervals of 5 mm on the side opposite to the side from which the positive-negative-electrode charge collector or the positive-electrode charge collector protruded and was exposed.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 5

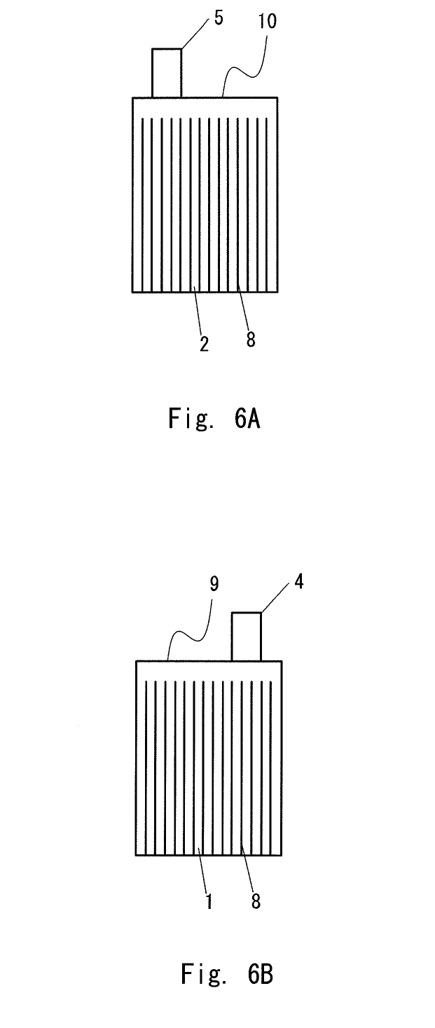

FIGS. 6A and 6B show a fifth configuration example of an electric storage device according to the present invention. In particular, FIG. 6A is a top view of a negative-electrode sheet and FIG. 6B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. Fourteen cuts 8 having a length of 35 mm were formed with intervals of 2 mm, in each sheet, on the side opposite to the side from which the negative-electrode charge collector 5 or the positive-electrode charge collector 4 protruded and was exposed.

Lithium ion capacitors were manufactured in a similar manner to that of Example 1 except that the fourteen cuts having a length of 35 mm were formed with intervals of 2 mm on the side opposite to the side from which the negative-electrode charge collector or the positive-electrode charge collector protruded and was exposed.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 6

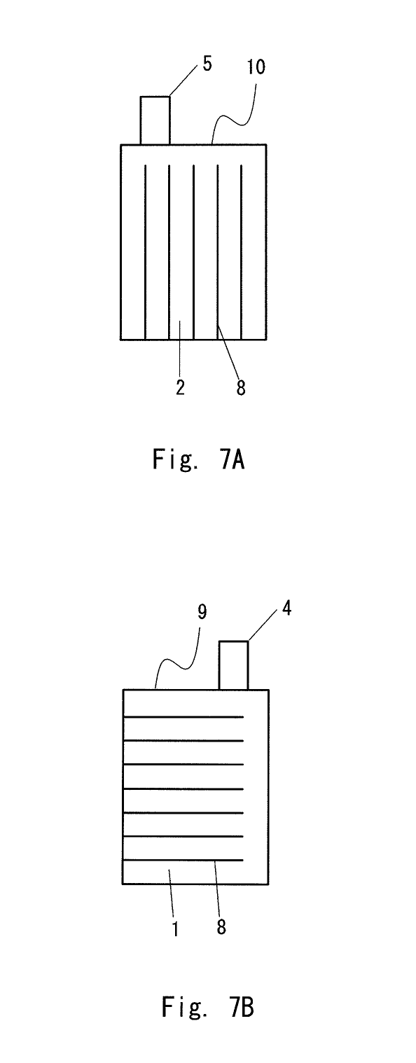

FIGS. 7A and 7B show a sixth configuration example of an electric storage device according to the present invention. In particular, FIG. 7A is a top view of a negative-electrode sheet and FIG. 7B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. Five cuts 8 having a length of 35 mm were formed with intervals of 5 mm on the side opposite to the side from which the negative-electrode charge collector 5 protruded and was exposed, and seven cuts 8 having a length of 25 mm were formed with intervals of 5 mm on one of the sides adjacent to the side from which the positive-electrode charge collector 4 protruded and was exposed.

Lithium ion capacitors were manufactured in a similar manner to that of Example 1 except that the five cuts having a length of 35 mm were formed with intervals of 5 mm on the side opposite to the side from which the negative-electrode charge collector protruded and was exposed and the seven cuts having a length of 25 mm were formed with intervals of 5 mm on one of the sides adjacent to the side from which the positive-electrode charge collector protruded and was exposed.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 7

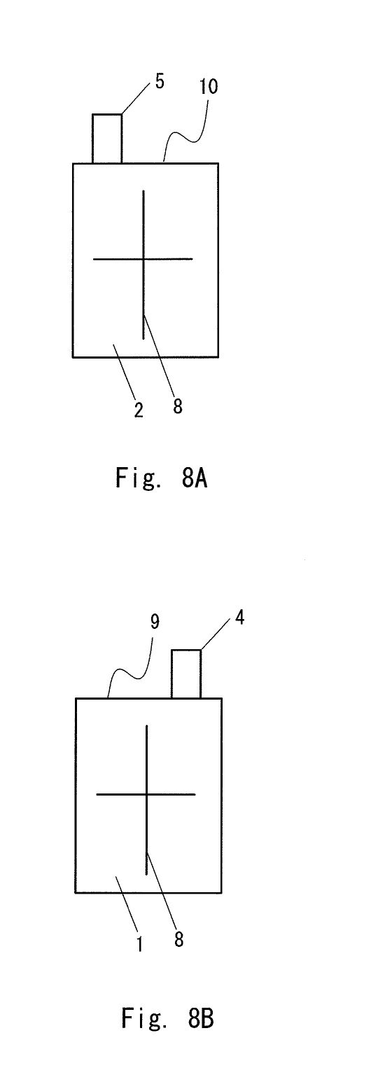

FIGS. 8A and 8B show a seventh configuration example of an electric storage device according to the present invention. In particular, FIG. 8A is a top view of a negative-electrode sheet and FIG. 8B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. In each of the negative-electrode charge collector 5 and the positive-electrode charge collector 4, a lengthwise cut 8 having a length of 30 mm and a crosswise cut 8 having a length of length of 20 mm were formed at the center in such a manner that the lengthwise and crosswise cuts intersect each other.

Lithium ion capacitors were manufactured in a similar manner to that of Example 1 except that in each of the negative-electrode charge collector and the positive-electrode charge collector, the 30-mm lengthwise cut and the 20-mm crosswise cut were formed at the center in such a manner that the cuts intersect each other.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Example 8

FIGS. 10A and 10B show an eighth configuration example of an electric storage device according to the present invention. In particular, FIG. 10A is a top view of a negative-electrode sheet and FIG. 10B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. Five cuts 8 having a length of 34 mm were formed with intervals of 5 mm in each of the negative-electrode charge collector 5 and the positive-electrode charge collector 4. The ends 20 of these cuts 8 did not reach the side 21 opposite to the side from which the negative-electrode charge collector 5 or the positive-electrode charge collector 4 protruded and was exposed. That is, the side 21 was not torn apart. Lithium ion capacitors were manufactured in a similar manner to that of Example 1 except for the above-described feature.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Comparative Example 1

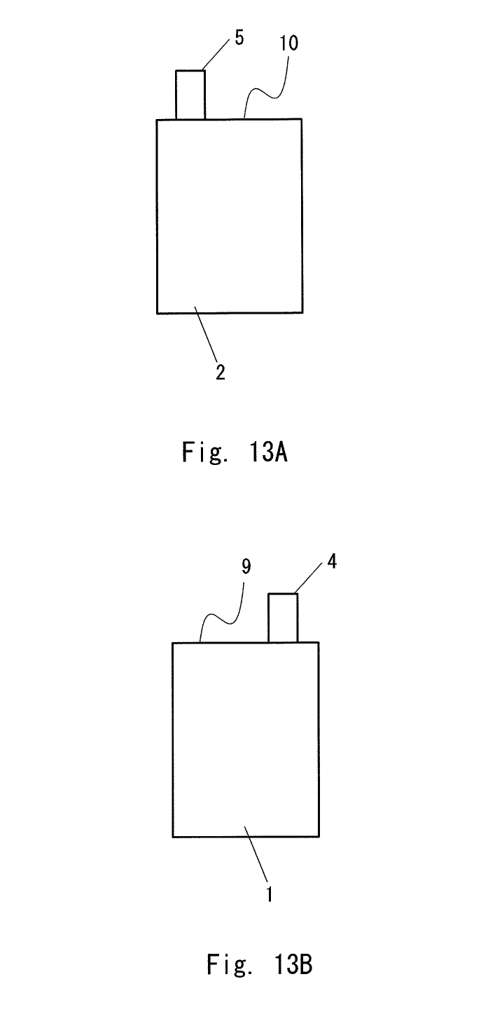

FIGS. 13A and 13B show a first configuration example of an electric storage device in related art. In particular, FIG. 13A is a top view of a negative-electrode sheet and FIG. 13B is a top view of a positive-electrode sheet. In the negative-electrode sheet 10, a coating of a negative-electrode active material layer 2 was applied in a rectangular shape to the negative-electrode charge collector 5 formed from a foil. Further, in the positive-electrode sheet 9, a coating of a positive-electrode active material layer 1 was applied in a rectangular shape to the positive-electrode charge collector 4 formed from a foil. No cut was formed in the negative-electrode charge collector 5 and the positive-electrode charge collector 4.

Lithium ion capacitors were manufactured in a similar manner to that of Example 1 except that no cut was formed in the negative-electrode charge collector and the positive-electrode charge collector.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

### Comparative Example 2

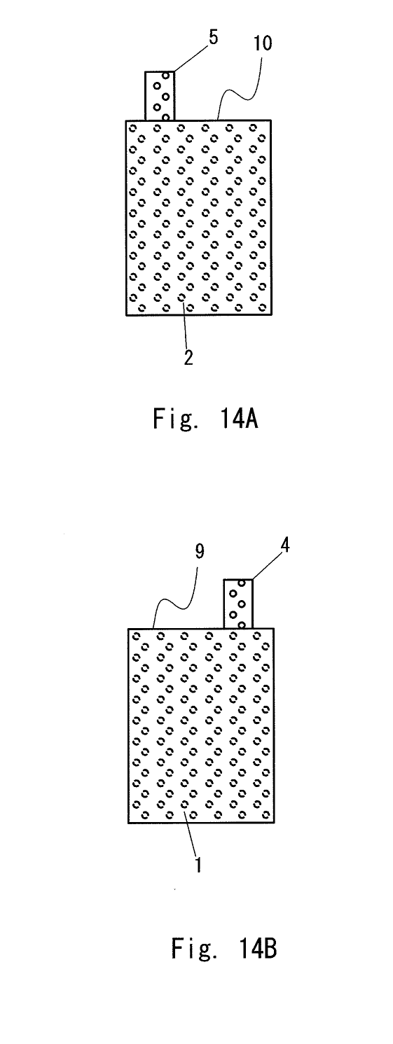

FIGS. 14A and 14B show a second configuration example of an electric storage device in related art. In particular, FIG. 14A is a top view of a negative-electrode sheet and FIG. 14B is a top view of a positive-electrode sheet. In the negative-electrode sheet 10, a coating of a negative-electrode active material layer 2 was applied in a rectangular shape to the negative-electrode charge collector 5 formed from a porous lath foil. Further, in the positive-electrode sheet 9, a coating of a positive-electrode active material layer 1 was applied in a rectangular shape to the positive-electrode charge collector 4 formed from a porous lath foil. No cut was formed in the negative-electrode charge collector 5 and the positive-electrode charge collector 4.

The positive-electrode charge collector was an aluminum porous lath foil having a thickness of 30 μm, and the negative-electrode charge collector was a copper porous lath foil having a thickness of 25 μm. Lithium ion capacitors were manufactured in a similar manner to that of Example 1 except that no cut was formed in the negative-electrode charge collector and the positive-electrode charge collector.

A constant-voltage discharge was carried out on the manufactured lithium ion capacitor so that 450 mAh/g of lithium ions were doped into the negative-electrode active material layer from the lithium metal. In this process, the doping time was measured.

In the above-described state, an ESR of the cell was measured by using the positive-electrode active material layer as the counter electrode. The ESR at a frequency of 1 kHz was measured by using an LCR meter. After that, it was charged for one hour with a constant current at a constant voltage of 3.8V, and then discharged at 80 mA until the cell voltage became 2.2V. The DC resistance was calculated based on the voltage drop during the discharging process.

Table 1 collectively shows measurement results of the doping time, the ESR, and the DC resistance in Examples 1 to 8 and Comparative examples 1 and 2. These values represent average values over twenty manufactured lithium ion capacitors.

TABLE 1

| | | Ratio of cut | | | | |
|---|---|---|---|---|---|---|
| | Interval | length to | | | | DC |
| | between | sum of four | | Doping | | resis- |
| | cuts | sides | Charge | time | ESR | tance |
| | (mm) | (%) | collector | (H) | (mΩ) | (mΩ) |
| Example 1 | 15 | 10 | Foil | 29 | 57 | 119 |
| Example 2 | 10 | 50 | Foil | 22 | 55 | 111 |
| Example 3 | 5 | 125 | Foil | 12 | 52 | 104 |
| Example 4 | 5 | 125 | Porous | 8 | 107 | 214 |
| | | | lath foil | | | |
| Example 5 | 2 | 350 | Foil | 7 | 52 | 106 |
| Example 6 | 5 | 125 | Foil | 13 | 53 | 115 |
| Example 7 | — | 35 | Foil | 24 | 57 | 112 |
| Example 8 | 5 | 121 | Foil | 12 | 53 | 105 |
| Compar- | — | — | Foil | 30 | 58 | 120 |
| ative | | | | | | |
| example 1 | | | | | | |
| Compar- | — | — | Porous | 11 | 108 | 225 |
| ative | | | lath foil | | | |
| example 2 | | | | | | |

The diffusion distances of lithium ions are different depending on whether the charge collector is formed from a foil or a porous lath foil, and this difference affects the doping time, the ESR, and the DC resistance. Therefore, the results were divided into two categories and have been examined separately.

As can be seen from Table 1, when Examples 1, 2, 3, 5, 6, 7 and 8 are compared with Comparative example 1, Examples 1, 2, 3, 5, 6, 7 and 8 have shorter doping times, smaller ESRs, and smaller DC resistances in comparison to those of Comparative example 1. Further, when Example 4 is compared to Comparative example 2, Example 4 has a shorter doping time, a smaller ESR, and a smaller DC resistance in comparison to those of Comparative example 2.

It has been found out that for both of the foil or the porous lath foil, the doping time can be reduced by forming a lot of cuts and narrowing the intervals, and/or by increasing the ratio of the sum of lengths of the cuts to the sum of lengths of the four sides.

Further, it has been observed that the use of a foil reduces the DC resistance by about 50% in comparison to the use of a porous lath foil. It is presumed that since the diffusion distance of lithium ions becomes shorter, the doping time is also reduced. Further, since a foil has a better charge-collecting property than a porous lath foil, the use of a foil as the charge collector reduces the resistance.

A similar experiment to the above-described experiment has been also carried out for lithium-ion secondary batteries in which doping is carried out, and a similar result to that shown in Table 1 was obtained. Based on this result, it has been found out that, by forming cuts, a lithium-ion secondary battery in which doping is carried out also has a shorter doping time, a smaller ESR, and a smaller DC resistance.

According to the present invention, it has been observed that the diffusion distance of lithium ions become shorter by forming a lot of cuts and narrowing the intervals. Therefore, it is possible to provide an electric storage device whose negative electrode can be doped with lithium ions in a short time and whose resistance can be lowered.

Although exemplary embodiments according to the present invention have been explained by using examples, the present invention is not limited to these examples. Any design changes made without departing from the scope and the spirit of the present invention are also included in the present invention. That is, various modifications and corrections that could be made by those skilled in the art without difficulty are also included in the present invention.

This application is based upon and claims the benefit of priority from Japanese patent application No. 2010-087434, filed on Apr. 6, 2010, the disclosure of which is incorporated herein in its entirety by reference.

### INDUSTRIAL APPLICABILITY

An electric storage device according to the present invention can be used, for example, as an energy source for driving a motor used in electric vehicles and as the key device of energy regenerative systems. Further, an electric storage device according to the present invention is a device whose applications to various new purposes such as applications to uninterrupted power supply systems, wind power generators, and solar power generators are studied, and a device that has been highly expected to be the next-generation device.

### REFERENCE SIGNS LIST

1 POSITIVE-ELECTRODE ACTIVE MATERIAL LAYER
2 NEGATIVE-ELECTRODE ACTIVE MATERIAL LAYER
3 SEPARATOR
4 POSITIVE-ELECTRODE CHARGE COLLECTOR
5 NEGATIVE-ELECTRODE CHARGE COLLECTOR
6 ELECTROLYTIC SOLUTION
7 LITHIUM METAL
8 CUT
9 POSITIVE-ELECTRODE SHEET
10 NEGATIVE-ELECTRODE SHEET
11, 30 ELECTRIC STORAGE DEVICE

1. An electric storage device comprising a unit that is obtained by alternately stacking a positive-electrode sheet and a negative-electrode sheet with a separator interposed therebetween, the positive electrode sheet comprising a positive-electrode active material layer and a positive-electrode charge collector, and the negative electrode sheet comprising a negative-electrode active material layer and a negative-electrode charge collector, wherein
a foil, an etching foil, or a porous lath foil is used as the positive-electrode charge collector and the negative-electrode charge collector,
a cut is made in a coating area of the positive-electrode active material layer and the negative-electrode active material layer, and
a lithium supply source is disposed so as to be opposed to the negative electrode sheet of the unit.

2. The electric storage device according to claim 1, wherein
each of the positive-electrode active material layer and the negative-electrode active material layer has a quadrangular shape, and
in each of the positive-electrode sheet and the negative-electrode sheet, a ratio of a sum of a length of the cut to a sum of lengths of four sides of the positive-electrode active material layer and the negative-electrode active material layer is not less than 10% and not greater than 100,000%.

3. The electric storage device according to claim 1, wherein a number of the cut in the coating area of each of the positive-electrode active material layer and the negative-electrode active material layer is not less than 2 and not greater than 4,000.

4. The electric storage device according to claim 1, wherein an interval between the cuts is not smaller than 0.1 mm and not greater than 10 cm.

5. The electric storage device according to claim 1, wherein an end of the cut does not reach a side of the positive-electrode sheet or the negative-electrode sheet.

6. The electric storage device according to claim 1, wherein a plurality of units each of which is obtained by stacking the positive-electrode sheet, the negative-electrode sheet, and the separator are connected to one lithium supply source.

7. The electric storage device according to claim 1, wherein the electric storage device is a hybrid capacitor or a lithium-ion secondary battery.

8. A method of manufacturing an electric storage device comprising a unit that is obtained by alternately stacking a positive-electrode sheet and a negative-electrode sheet with a separator interposed therebetween, the positive electrode sheet comprising a positive-electrode active material layer and a positive-electrode charge collector, and the negative electrode sheet comprising a negative-electrode active material layer and a negative-electrode charge collector, the method comprising:
using a foil, an etching foil, or a porous lath foil as the positive-electrode charge collector and the negative-electrode charge collector;
forming a cut in a coating area of the positive-electrode active material layer and the negative-electrode active material layer; and
disposing a lithium supply source in such a manner that the lithium supply source is opposed to the negative electrode sheet of the unit.

9. The method of manufacturing an electric storage device according to claim 8, wherein
each of the positive-electrode active material layer and the negative-electrode active material layer has a quadrangular shape, and
in each of the positive-electrode sheet and the negative-electrode sheet, a ratio of a sum of a length of the cut to a sum of lengths of four sides of the positive-electrode active material layer and the negative-electrode active material layer is not less than 10% and not greater than 100,000%.

10. The method of manufacturing an electric storage device according to claim 8, wherein a number of the cut in the coating area of each of the positive-electrode active material layer and the negative-electrode active material layer is not less than 2 and not greater than 4,000.

11. The method of manufacturing an electric storage device according to claim 8, wherein an interval between the cuts is not smaller than 0.1 mm and not greater than 10 cm.

12. The method of manufacturing an electric storage device according to claim 8, wherein an end of the cut does not reach a side of the positive-electrode sheet or the negative-electrode sheet.

13. The method of manufacturing an electric storage device according to claim 8, wherein a plurality of units each of which is obtained by stacking the positive-electrode sheet, the negative-electrode sheet, and the separator are connected to one lithium supply source.

14. The method of manufacturing an electric storage device according to claim 8, wherein the electric storage device is a hybrid capacitor or a lithium-ion secondary battery.
